(19) United States
(12) Patent Application Publication
(10) Pub. No.: US 2013/0208290 A1
(43) Pub. Date: Aug. 15, 2013

(54) CHECKING SYSTEM, CONTROL METHOD OF CHECKING SYSTEM, AND STORAGE MEDIUM

(71) Applicant: CANON KABUSHIKI KAISHA, (US)

(72) Inventor: Daiki Ikari, Yokohama-shi (JP)

(73) Assignee: CANON KABUSHIKI KAISHA, Tokyo (JP)

(21) Appl. No.: 13/756,024

(22) Filed: Jan. 31, 2013

(30) Foreign Application Priority Data
Feb. 15, 2012 (JP) 2012-030522

(51) Int. Cl. H04N 1/00

(52) U.S. Cl. CPC H04N 1/00071
USPC 358/1.12

(57) ABSTRACT

A checking system includes a checking unit and a control unit. The checking unit checks a print product, printed by a printing unit, by using a reading unit to read the print product. The control unit perform controls. In response to the reading unit being normal and the checking unit determining a print product as normal, the print product is discharged to a first sheet discharging unit. In response to the reading unit being normal and the checking unit determining a print product as abnormal, the print product is discharged to a second sheet discharging unit that is different from the first sheet discharging unit. In response to the reading unit being abnormal, the print product is discharged to a third sheet discharging unit that is different from the first sheet discharging unit and the second sheet discharging unit.

### BACKGROUND OF THE INVENTION

1. Field of the Invention

The present invention relates to a checking system, a control method for controlling the checking system, and a storage medium thereof.

2. Description of the Related Art

Japanese Patent Laid-Open Application No. 2007-85870 discusses a checking system comprising a printing apparatus and a checking apparatus connected to each other in order to cause the checking apparatus to check a print product printed and output by the printing apparatus. The checking system reads the print product by a reading unit to recognize quality of the read print product and, in a case where the print product does not have desired quality, the print product is discharged to a paper discharge destination different from an original paper discharge destination.

In the checking system as described above, an abnormality may occur in the reading unit. Examples of the abnormality include a case where a lens of the reading unit is contaminated or dust attaches to the lens or a case where a light source is deteriorated. In a case where such abnormality occurs, the checking system determines that the print product is not normally printed even when the print product itself is normally printed.

In this case, a user cannot know with ease whether the print product is not determined as normally printed since the quality of the print product is not a desired quality or since there is an abnormality about the reading unit. Therefore, the user may reprint all the pages since the checking system determined the print product as not normally printed although the print product is normally printed, so that the reprinted pages may go to waste.

### SUMMARY OF THE INVENTION

According to an aspect of the present invention, a checking system includes a checking unit configured to check a print product, printed by a printing unit, by using a reading unit to read the print product, and a control unit configured to perform control, wherein, in response to the reading unit being normal and the checking unit determining a print product as normal, the print product is discharged to a first sheet discharging unit, wherein, in response to the reading unit being normal and the checking unit determining a print product as abnormal, the print product is discharged to a second sheet discharging unit that is different from the first sheet discharging unit, and wherein, in response to the reading unit being abnormal, the print product is discharged to a third sheet discharging unit that is different from the first sheet discharging unit and the second sheet discharging unit.

The checking system provides a system allowing a user to specify with ease the print product determined as not normal due to abnormality of a checking unit in a case where there is an abnormality in the checking unit. Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a printing system according to the present exemplary embodiment.

FIG. 2 is a block diagram illustrating a configuration of the printing apparatus illustrated in FIG. 1.

FIG. 3 is a cross sectional view illustrating a configuration of an inside of the printing apparatus illustrated in FIG. 1.

FIG. 4 is a block diagram illustrating a configuration of a control unit of a checking apparatus illustrated in FIG. 1.

FIGS. 5A and 5B are cross sectional views illustrating a configuration of an inside of the checking apparatus illustrated in FIG. 1, respectively.

FIG. 6 is a block diagram illustrating a flow of processing performed by a check determination unit of the checking apparatus illustrated in FIG. 1.

FIGS. 7A and 7B illustrate check processing for checking a skew of an image on a sheet to be conveyed in the checking apparatus and determination processing thereof, respectively.

FIGS. 8A, 8B, 8C, and 8D illustrate check processing performed by the checking apparatus.

FIGS. 9A, 9B, 9C, 9D, and 9E illustrate another check processing performed by the checking apparatus.

FIG. 10 is a block diagram illustrating a flow of processing performed by an error determination unit of the checking apparatus illustrated in FIG. 1.

FIG. 11 is a cross sectional view illustrating an example of a configuration of a finisher (i.e., a post-processing apparatus) illustrated in FIG. 1.

FIG. 12 is a block diagram illustrating a configuration of a control system of the finisher illustrated in FIG. 1.

FIG. 13 is a flow chart illustrating a control method of the printing system according to the present exemplary embodiment.

FIG. 14 is a flow chart illustrating a control method of the checking apparatus according to the present exemplary embodiment.

FIG. 15 is a table illustrating an example of a comprehensive determination result generated by the checking apparatus according to the present exemplary embodiment.

FIG. 16 is a flow chart illustrating a control method of the finisher according to the present exemplary embodiment.

FIG. 17 is a flow chart illustrating a control method of the printing system according to the present exemplary embodiment.

FIG. 18 illustrates an example of an error report to be output by the printing apparatus according to the present exemplary embodiment.

FIGS. 19A and 19B illustrate examples of a user interface (UI) screen which can be displayed by the printer apparatus according to the present exemplary embodiment.

### DESCRIPTION OF THE EMBODIMENTS

Various exemplary embodiments, features, and aspects of the invention will be described in detail below with reference to the drawings. <Description of System Configuration>

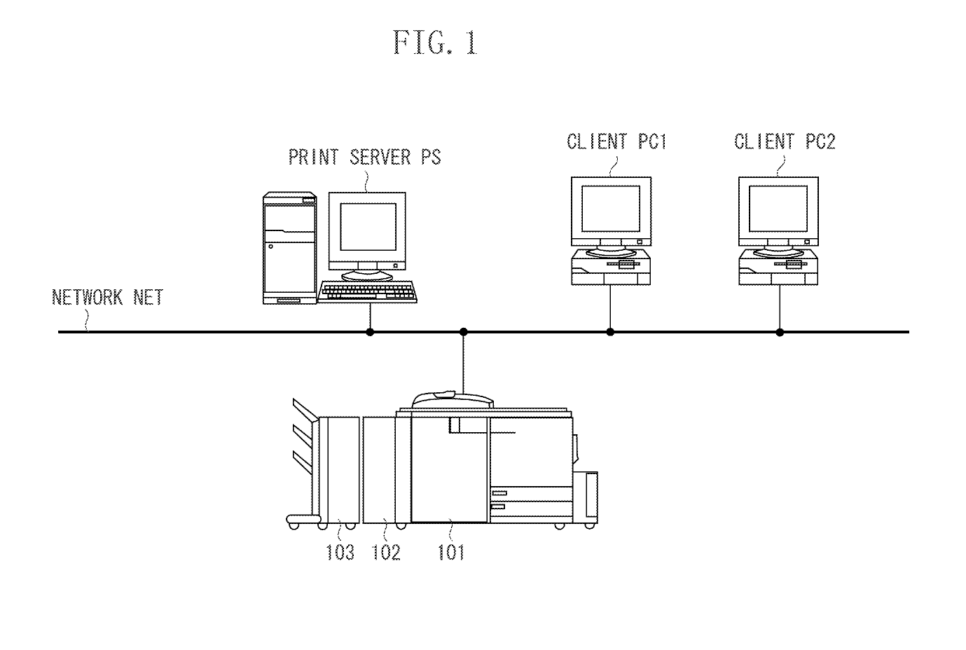

FIG. 1 illustrates a configuration of a printing system (i.e., a checking system) according to a first exemplary embodiment. FIG. 1 illustrates an example in which the printing system including a checking apparatus is connected to a plurality of client personal computers (PCs) and a print server via a network. Referring to FIG. 1, the printing system includes the checking apparatus for reading a sheet conveyed from the printing apparatus to determine the print quality of the printed image to output a checked result and a post-processing apparatus comprising a plurality of output trays for discharging a sheet checked by the checking apparatus.

In FIG. 1, a printing apparatus 101 processes various types of input data to output the data for printing. A checking apparatus 102 reads an image on a sheet output from the printing apparatus 101 to compare thus read image with print data in order to check a printed state of the image. A finisher 103 receives the output sheet having been checked by the checking apparatus 102. The printing apparatus 101 is connected to external devices such as a print server PS, a client PC 1, and a client PC 2 via a network NET. In the present exemplary embodiment, print processing, image check processing, and finishing processing are consistently performed, so that each unit is configured such that the sheet can be delivered therebetween.

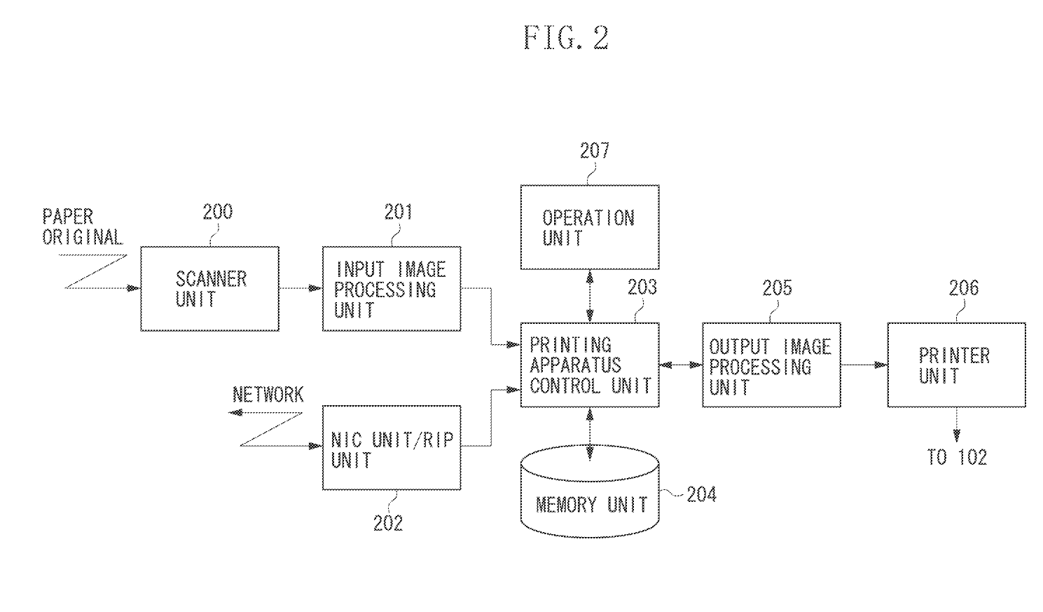

FIG. 2 is a block diagram illustrating a configuration of the printing apparatus 101 illustrated in FIG. 1. In FIG. 2, a scanner unit 200 functions as an image reading unit such as an image scanner for reading a paper original. An input image processing unit 201 executes image processing, e.g., a shading correction and a gamma correction, by using a publicly known technique with respect to image data read by the scanner unit 200.

A Network Interface Card (NIC) unit/Raster Image Processor (RIP) unit 202 delivers image data (mainly, Page Description Language (PDL) data) input by using the network to the RIP unit and transmits image data and device information within the printing apparatus 101 to the external devices via a network. The RIP unit of the NIC unit/RIP unit 202 interprets thus input PDL data to render it into a raster image.

A printing apparatus control unit 203 controls thus input image data and data to be output. The image data input into the printing apparatus control unit 203 is temporarily stored in a memory unit 204. Thus stored image data is temporarily stored or is invoked, as required.

An output image processing unit 205 performs image processing for printing and outputting the input image, and transmits thus processed image to a printer unit 206. The printer unit 206 feeds sheets and sequentially prints images formed by the output image processing unit 205 on the sheet. The sheet thus printed and output is transmitted to the checking apparatus 102. An operation unit 207 selects the above described various flows and functions, or gives instructions to operate the flows and functions.

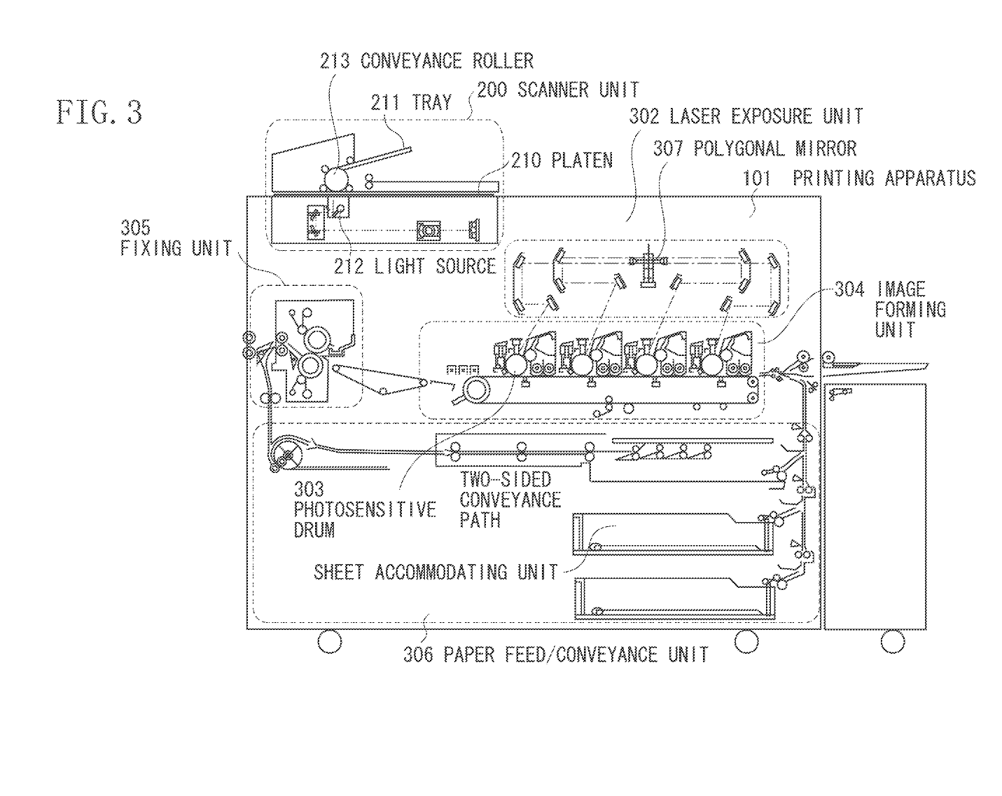

FIG. 3 is a cross sectional view illustrating a configuration of an inside of each of the scanner unit 200 and the printer unit 206 within the printing apparatus 101 illustrated in FIG. 1.

In FIG. 3, the printing apparatus 101 includes the printer unit 206 including the scanner unit 200, a laser exposure unit 302, a photosensitive drum 303, an image forming unit 304, a fixing unit 305, and a paper feed/conveyance unit 306, and the control unit 203 for controlling the above units illustrated in FIG. 2.

The scanner unit 200 irradiates a document placed on a platen 210 or a tray 211 with light of a light source 212 to optically read a document image of the document and converts the read document image into an electrical signal to generate image data thereof. In a case where a plurality of documents are continuously read, a conveyance roller 213 conveys the plurality of documents placed on the tray 211 to a position where the documents can be irradiated with the light of the light source 212 sequentially sheet by sheet. Then, the scanner unit 200 reads the document image at the position. Thus read document is further conveyed to a paper discharge opening by the conveyance roller 213.

Accordingly, the printing apparatus 101 can continuously automatically read the plurality of documents. At the same time, the scanner unit 200 executes dust check processing. The dust check processing is executed such that the scanner unit 200 reads a white surface of the conveyance roller 213 of a section lying between sheets being conveyed, i.e., a section at which no document is read. The scanner 200 detects dust by checking whether there is black data, instead of white data, of a value equal to or less than a certain threshold in the read out white data.

In a case where the scanner 200 detects dust here, the scanner 200 can determine that dust or dirt is attaching to the white surface of the conveyance roller 213 or a platen between the light source and the conveyance roller 213. A determination result thereof is notified to the input image processing unit 201 where processing for substituting pixel data at a position corresponding to the position of the dust with an adjacent normal pixel is performed to reduce an adverse effect of the dust on the read image.

A laser exposure unit 302 causes a light beam such as laser light which is modulated according to the above described image data to enter into a rotating polygon mirror (i.e., a polygonal mirror) 307 which is rotating at a constant angular velocity, thereby applying the light beam to the photosensitive drum 303 as reflection scan light.

An image forming unit 304 drives the photosensitive drum 303 to rotate and charges the photosensitive drum 303 by a charging device. The laser exposure unit 302 develops a latent image formed on the photosensitive drum 303 with a toner. Then, the developed toner image is transferred onto a sheet. Four serial developing units (i.e., developing stations) perform a series of electrophotographic process in which minute toners remaining on the photosensitive drum 303 without being transferred are collected.

The four serial developing units aligned in an order of cyan (c), magenta (M), yellow (Y), and black (K) sequentially executes image forming operation for forming a magenta image, a yellow image, and a black image after a predetermined time has lapsed from a start of the image formation performed in the cyan station. According to the above described timing control, a full color toner image with no color misregistration can be transferred onto the sheet. The present exemplary embodiment is a full color printer but is not limited thereto. That is, in a case of a monochrome printer, only a developing unit for black is mounted on the printer.

A fixing unit 305 includes a combination of a roller and a belt and includes therein a heat source such as a halogen heater. Accordingly, the toners on the sheet to which the toner image is transferred by the image forming unit are melted and fixed to the sheet by heating and pressurizing.

A paper feed/conveyance unit 306 has more than one sheet accommodating unit, i.e., a sheet cassette and a paper deck, and separates apiece of sheet from a plurality of sheets accommodated in the sheet accommodating unit according to an instruction of the printer control unit. The paper feed/conveyance unit 306 conveys the separated sheet to the image forming unit 304 and the fixing unit 305. The paper feed/conveyance unit 306 further conveys the sheet to the developing stations where toner images of the respective colors are transferred onto the sheet, thereby finally forming a full color toner image on the sheet.

In a case where the images are formed on both sides of the sheet, the sheet having passed through the fixing unit 305 is controlled so as to pass through the conveyance path which conveys the sheet to the image forming unit 304 again.

A control unit of the scanner unit 200 and a control unit of the printer unit 206 communicate with the printing apparatus control unit 203 which controls the entire printing apparatus, thereby executing the control according to an instruction of the printing apparatus control unit 203. The control unit of the printer unit 206 manages the control of the entire printing apparatus as well as a state of each of the scanner unit, the laser exposure unit, the image forming unit, the fixing unit, the paper feeding/conveyance unit and gives instructions such that the entire printing apparatus can smoothly operate as a whole.

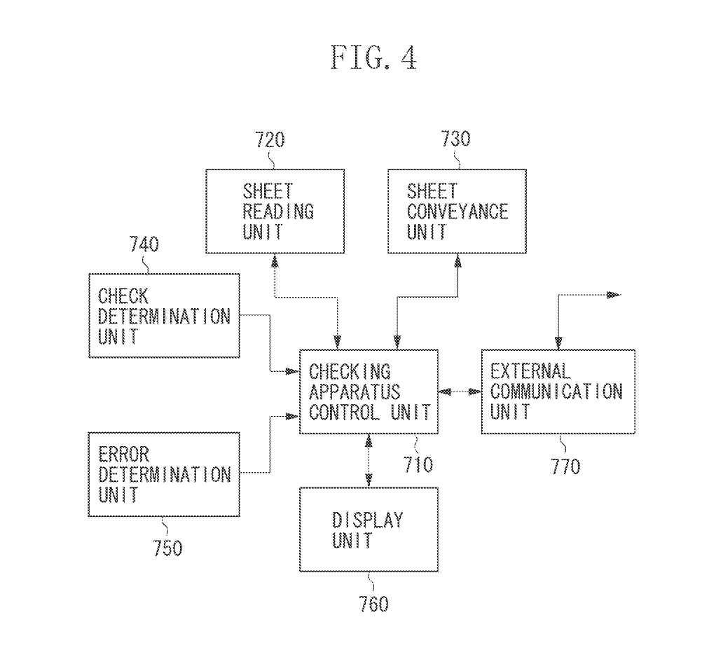

FIG. 4 is a block diagram illustrating a configuration of a control unit of the checking apparatus 102 illustrated in FIG. 1. In FIG. 4, a checking apparatus control unit 710 controls the checking apparatus as a whole and collectively controls units 720 through 770 as described below. The sheet reading unit 720 controls the image reading apparatus such as a scanner to read a sheet conveyed from the printing apparatus 101 including an image formed thereon.

A sheet conveyance unit 730 conveys the sheet conveyed from the printing apparatus 101 to the reading unit 720 and further controls conveying and discharging of the read sheet to the outside of the apparatus.

A check determination unit 740 compares image data of the read sheet with reference data to determine whether the image data of the sheet has quality more than at a certain level (i.e., whether a difference between the image data and the reference data is within a range of a certain permissible amount). A detailed description of the check determination is described below.

An error determination unit 750 determines whether the checking apparatus 102 itself can normally read the image on the sheet. In a case where the error determination unit 750 determines that the checking apparatus 102 cannot normally read the image on the sheet, the error determination unit 750 outputs information indicative of a checking apparatus error in addition to a normal check error. A detailed description of the processing for outputting the information indicative of the checking apparatus error is described below.

A display unit 760 displays a determination result obtained by the check determination unit 740 and a determination result obtained by the error determination unit 750 in the form of a report as described below, as required.

A checking apparatus control unit 710 communicates with the printing apparatus control unit 203 within the printing apparatus 101 via the external communication unit 770. At the time, the printing apparatus control unit 203 determines whether the check determination result is OK or NG and whether the checking apparatus error occurred via the communication. According to a result thereof, the printing apparatus control unit 203 controls an operation of each unit and a switching of the sheet discharge destination with respect to a plurality of output trays of the finisher 103 including a sheet discharge destination on which the image is formed by the printing apparatus 101.

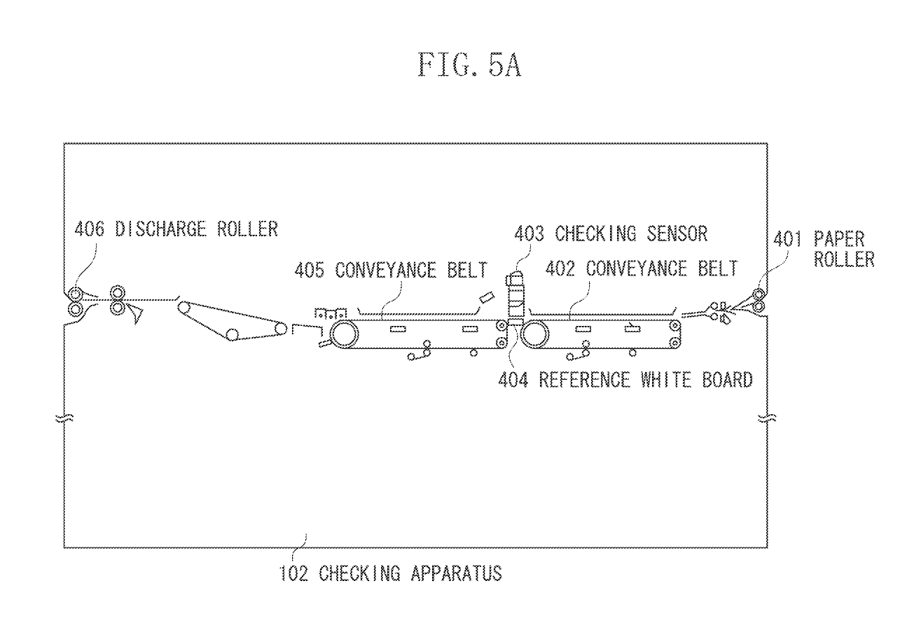

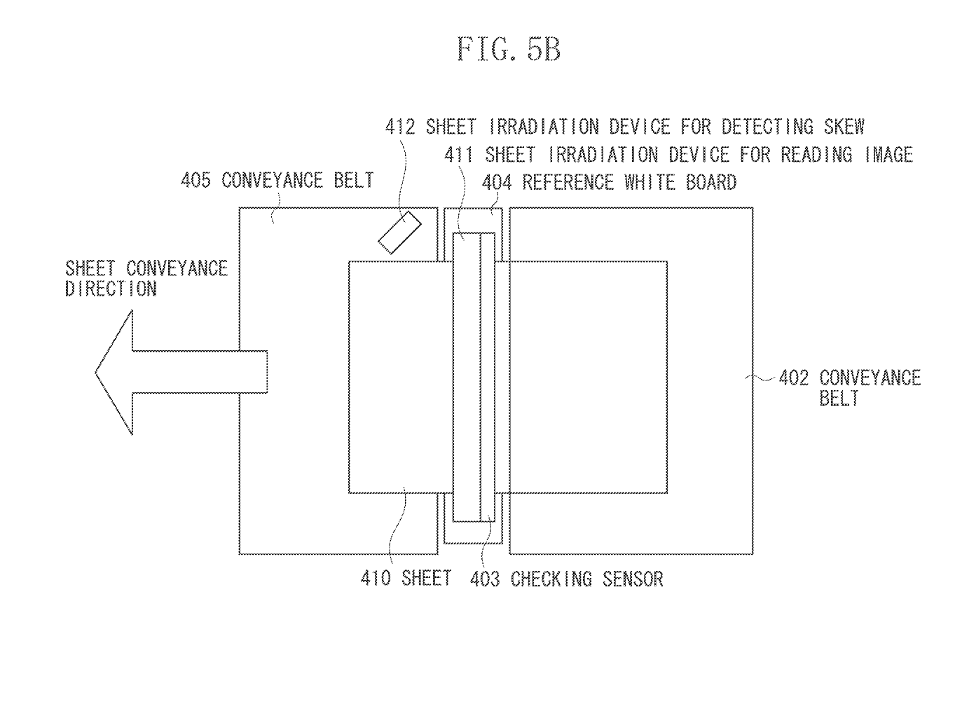

FIG. 5 is a cross sectional view illustrating a configuration of an inside of the checking apparatus 102 illustrated in FIG. 1. FIG. 5A illustrates a cross sectional view of the checking apparatus 102 and FIG. 5B illustrates a plain view viewing from a top of the checking apparatus 102. More specifically, FIG. 5B illustrates a conveyance belt 402, a check sensor 403, and a conveyance belt 405 of the checking apparatus 102 viewed from the top. Configurations of a sheet reading unit 720 and a sheet conveyance unit 730 are described below.

In FIG. 5, the sheet printed and output from the printing apparatus 101 is drawn into the checking apparatus 102 by the paper roller 401. Then, while being conveyed on the conveyance belt 402, an image on the sheet is read by the check sensor 403 provided on a reference white board 404. The reference white board 404 is provided such that the check sensor 403 can normally read light reflected from the image. Thus read image data is used in the above described check determination unit 740.

After the check determination is made, the sheet is conveyed on the conveyance belt 405 and output via the discharge roller 406. Although it is not illustrated here, in order to permit a two-sided printing, it may be configured such that the check sensor 403 is disposed also below each of the conveyance belt 402 and the conveyance belt 405 to read a rear surface of the sheet.

In FIG. 5B, the check sensor 403 is a line sensor which reads the entire image of the sheet 410 thus conveyed line by line as illustrated. A sheet irradiation device 411 irradiates the sheet with light when reading the sheet by the check sensor 403. A sheet irradiation device for skew detection 412 reads whether the sheet 410 is skewed with respect to a sheet conveyance direction when the sheet is conveyed on the reference white board 404. The sheet irradiation device 412 for skew detection reads an image of a shadow extending along an edge portion of the sheet 410 by applying light obliquely to the sheet 410 while the sheet is conveyed, thereby detecting the skew of the sheet 410.

The reference white board 404 reflects light applied by the sheet irradiation device 411 for image reading and the sheet irradiation device 412 for skew detection to appropriately input the reflected light into the check sensor 403. In the present exemplary embodiment, the reading of the shadow image of the sheet edge portion is performed by the check sensor 403; however, the reading of the shadow image of the sheet edge portion may be performed by using a reading sensor other than the check sensor 403.

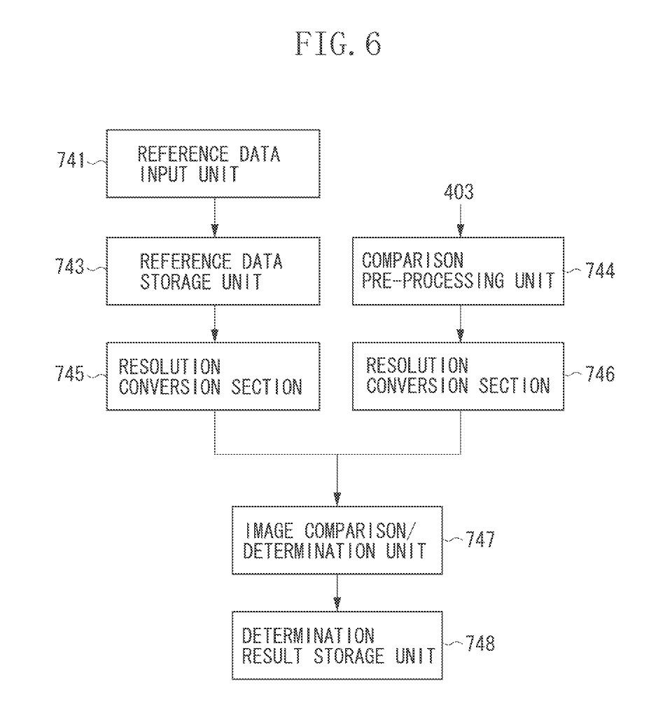

FIG. 6 is a block diagram illustrating a flow of processing performed by the check determination unit 740 of the checking apparatus 102 illustrated in FIG. 1.

In FIG. 6, a scanned image on the sheet that is read by the check sensor 403 under control of the sheet reading unit 720 is input into the comparison pre-processing unit 744 in the form of image data after being converted into an electrical signal. The comparison pre-processing unit 744 performs correction processing before the comparison processing such as the sheet skew correction with respect to the input image data. The sheet skew correction processing is performed as follows.

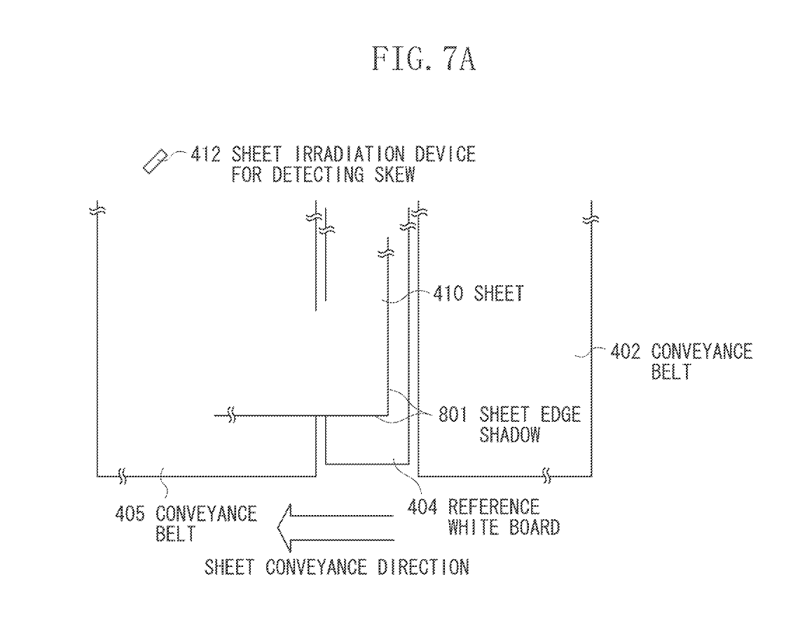

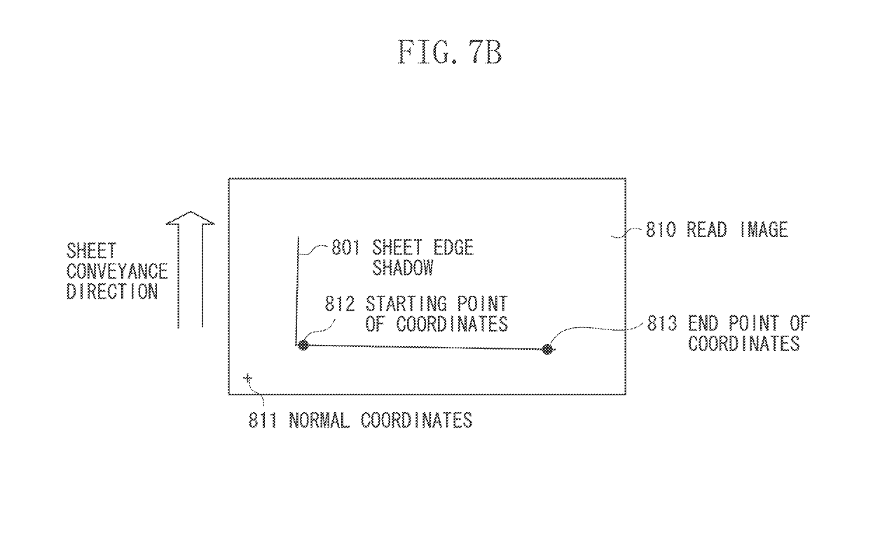

While the sheet is drawn into the checking apparatus 102 and conveyed on the reference white board 404 by the conveyance belt 402 and the conveyance belt 405, a shadow of a sheet edge portion created when the sheet is irradiated with light by the sheet irradiation device for skew detection 412 is read by the check sensor 403. Then, the check sensor 403 detects a difference between the shadow and a predetermined angle. The check processing and the determination processing of the skew of the sheet are described below with reference to FIGS. 7A and 7B.

The sheet 410 conveyed on the reference white board 404 is irradiated with light by the sheet irradiation device 412 for skew detection disposed obliquely with respect to the sheet conveyance direction and upwardly above the conveyance belt 402 and the conveyance belt 405. When the sheet 410 is irradiated with light, a sheet edge shadow 801 is created at a rear edge portion of the sheet 410.

The shadow is read by the check sensor 403. The read shadow image is subjected to binarization processing and edge detection processing in the comparison pre-processing unit 744 illustrated in FIG. 6. Accordingly, the skew of the shadow image is detected. At the time, with respect to the sheet edge shadow 801 to be used in this skew detection, either one of the sheet edge shadows 801 in a sheet conveyance direction and in a direction orthogonal to the sheet conveyance direction may be used or the sheet edge shadows 801 of both of those directions may be used by taking an average thereof.

With respect to the skew detection, for example, in a case where the image obtained when the image data read by the check sensor 403 is subjected to the binarization processing and the edge detection processing, is like the read image 810 of FIG. 7B, normal coordinates 811 are determined. Then, predetermined starting point of coordinates 812 and predetermined end point of coordinates 813 are determined on the sheet edge shadow 801 to determine each relative coordinates between the normal coordinates 811 and each coordinates.

In a case where the normal coordinates 811 are (0, 0), the starting point coordinates 812 are (300, 245), and the end point coordinates 813 are (235, 3885), a skew θ (deg) of the starting point coordinates 812 and the endpoint coordinates 813 can be obtained by Equation 1.

θ=tan⁻¹((235−300)/(3885−245))=−1.023(deg) [Equation 1]

Accordingly, according to a detection result, the sheet 410 is inclined by 1.023 degrees with respect to the sheet conveyance direction in a clockwise direction. Based on thus detected inclination angle and inclined rotation direction information, the entire image data read by the check sensor is subjected to rotation processing in the comparison pre-processing unit 744.

After the pre-comparison correction processing is carried out in the comparison pre-processing unit 744, the image data is transmitted to a resolution conversion section 746. On the other hand, the reference data as original data to be compared is input through a reference data input unit 741 to be stored in a reference data storage unit 743. The reference data may be input from the printing apparatus 101 via the network or may be taken in from a loading interface directly installed in the checking apparatus 102.

The reference data and the print product scan data are converted into equivalent resolution (e.g., 300 dpi) comparable to each other, respectively in the resolution conversion section 745 and the resolution conversion section 746, to be transmitted to an image comparison/determination unit 747. The data subjected to the image determination is stored in a determination result storage unit 748 and, if necessary, is displayed on a display unit 760 by the checking apparatus control unit 710.

Each of the reference data and the print output data is converted into a desired resolution by the respective corresponding resolution conversion sections 745 and 746 to be equivalent to each other and each resulting image is subjected to matching processing by using a bitmap image. In the present exemplary embodiment, the following two types of determination processing are performed.

(1) Determination processing of a difference between pixel values; and
(2) Determination processing of a shifting width between the images

The check determination may be performed by using only either one of the following two types of determination processing. Alternatively, in a case where the check determination is performed by using both types of the determination processing, the difference between the pixel values is detected after a skew correction is performed on page image data read by using inclination information of the image.

(1) In the determination processing of the difference between the pixel values, the light is applied to the sheet 410 by the sheet irradiation device for image reading 411 and the light reflected from the sheet 410 is read out by the check sensor 403. Differences of density values between pixels are calculated with respect to the read image data and whether the characters are printed correctly according to the values of the differences is determined. In a case of PDL printing, for example, the read image data is compared with data obtained by developing the PDL data as reference data.

Each of the reference data and the read image data is converted into a desired resolution by the corresponding resolution conversion section 745 and the resolution conversion section 746 respectively to be equivalent to each other. Each of the resulting images is subjected to the matching processing by using a bitmap image.

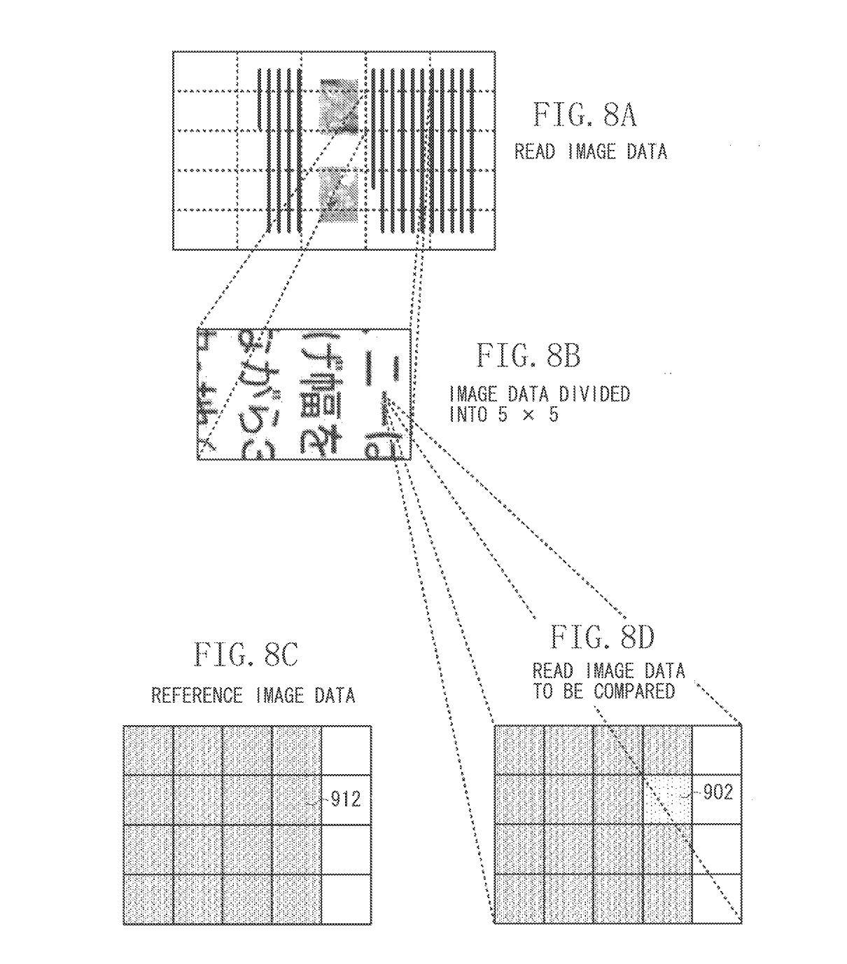

In the present exemplary embodiment, both of the image data are divided into, for example, 5×5 blocks and a density is compared per pixel in each block in Red, Green, and Blue (RGB) or in Cyan, Magenta, Yellow, and Black (CMYK). Whether performing the comparison in the RGB or in the CMYK can be set and changed according to the image. For example, in a case of full color image data, the comparison is performed in RGB and, in a case of black and white image data, the comparison is performed in the CMYK (i.e., only with K). FIG. 8 illustrates an example of image comparison for each 5×5 blocks.

FIG. 8A is image data read out by the check sensor 403. FIG. 8B is image data divided into 5×5 blocks after being subjected to a resolution conversion by the resolution conversion section 746. FIG. 8C illustrates a portion extracted from reference image data. FIG. 8D illustrates the portion extracted from the reference image data identical to the portion of FIG. 8B.

Density data, (multivalued data) in a range between 0 and 255, is compared with an absolute value of the comparison value calculated by the following Equation 2 and a permissible density difference preliminarily set as indicated by the following Inequality 3.

Comparison value=[data value obtained by scanning print sheet]−[density data value of reference image] [Equation 2]

|Comparison value|≦(permissible density difference) [Inequality 3]

In a case where the Inequality 3 is true, the pixel is determined as an OK image according to the below described flow chart and in other cases, the pixel is determined as an NG image. In a case of the example illustrated in FIG. 8, less density value is read in a position of a pixel 902 although a pixel value close to the black color should essentially be read due to attached dust of some sort.

In a case where a density difference threshold is set to a value “40”, an image density data value of a pixel 901 is set to a value 225, and an image density of the pixel 902 is set to a value “127”, if the values are substituted into Inequality 3, the Inequality 3 cannot be true as indicated in the following Equation 4.

|Comparison value|=|127−255|=128<≠40 [Inequality 4]

Based on the above, the comparison value is determined to be larger than the density threshold, so that the pixel is determined as the NG image.

Thus, the determination processing is equivalently performed with respect to each pixel within the 5×5 blocks to calculate a determination ratio of the OK image per block unit. The OK determination threshold set according to a desired method is compared with the determination ratio of the OK image per block unit. For example, in a case where the OK determination threshold is designated to be 90%, if the number of NG pixels within the block is one, a condition indicated by Inequality 5 becomes true.

Determination ratio (96%)>OK determination threshold (90%) [Inequality 5]

Consequently, the checking apparatus 102 determines that the block is OK as a result of the checking. In a case where the check determination processing is performed on the entire sheet and all the blocks are determined as the OK as a result of the checking, the sheet is determined as check OK, and in other cases, blocks are determined as check OK or check NG depending on the conditions.

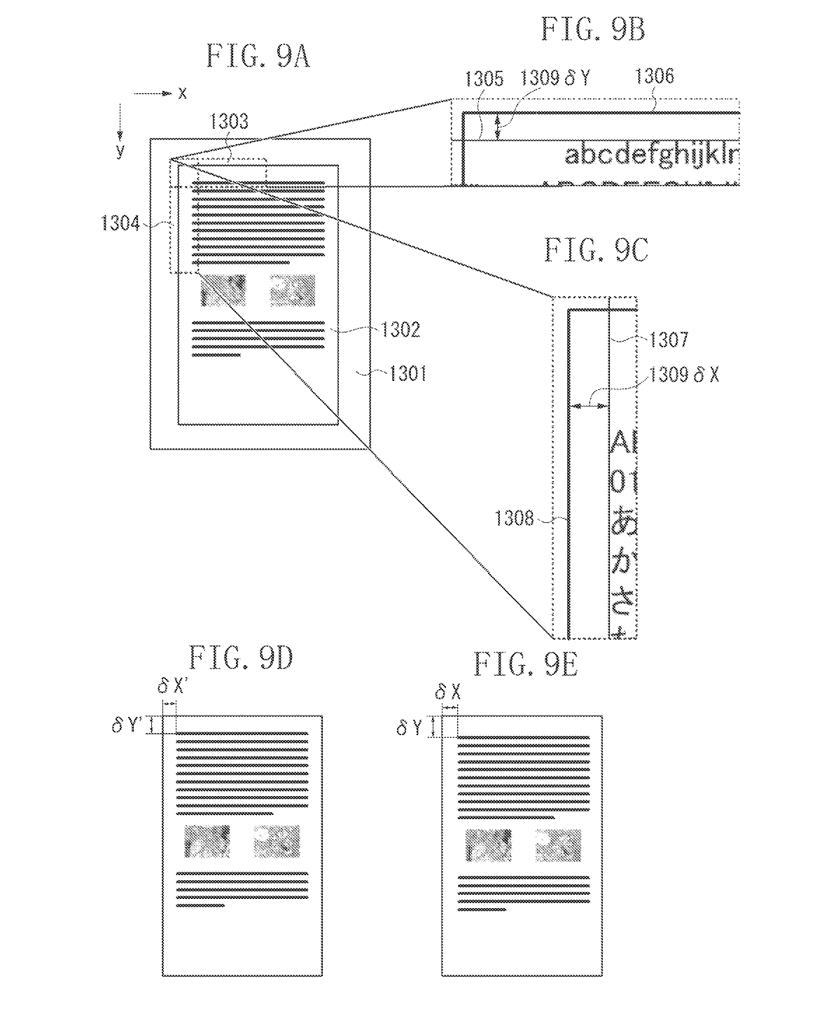

(2) The determination processing of the shifting width of the image is described below with reference to FIG. 9. Since document skew correction is performed as described above, it is assumed that there is no image skewed with respect to the sheet.
FIG. 9 illustrates check processing performed by the checking apparatus 102 illustrated in FIG. 1. FIG. 9A illustrates an image data read by the check sensor 403. FIG. 9A illustrates an entire area 1301 actually read by the check sensor 403, and a sheet area 1302. As described above, the sheet irradiation device for skew correction 412 can recognize the sheet edge portion as an image.

A rectangular area 1303 has a longitudinal side in an x direction of the sheet area 1302. A rectangular area 1304 has a longitudinal side in a y direction of the sheet area 1302. Each rectangular area is preliminarily determined based on a print setting. FIG. 9B illustrates an extracted image of the rectangular area 1303 having a longitudinal side in an x direction 1303. FIG. 9C is an extracted image of the rectangular area 1304 having a longitudinal side in a y direction.

In FIG. 9B, a straight line 1305 extends in parallel with the x direction passing through pixels having the minimum coordinates in the y direction of the character objects within the rectangular area 1303 having a longitudinal side in the x direction. A straight line 1306 indicates an edge portion parallel with the straight line 1305 of the sheet area 1302.

In FIG. 9C, a straight line 1307 passes in parallel with the y direction through pixels having the minimum coordinates in the x direction of the character objects within the rectangular area 1304 having the longitudinal side in the y direction. A straight line 1308 indicates an edge portion parallel with the straight line 1307 of the sheet area 1302.

Each of the straight line 1305 illustrated in FIG. 9B and the straight line 1307 illustrated in FIG. 9C is calculated and determined in a process as described below. Firstly, the read image data received by the image comparison/determination unit 747 is subjected to detection processing in the character object region and subsequently a black letter image is extracted according to density information of each pixel in the detected character object. Then, a black letter pixel existing on a most left side in the x direction in thus extracted black letter image is detected in FIG. 9A to determine an x coordinates of the pixel. Thus, a straight line passing through the x coordinates of the pixel in parallel with the y direction is determined.

Similarly, a black letter pixel existing on an uppermost side in the y direction in thus extracted black letter image is detected in FIG. 9A to determine a y coordinates of the pixel. Thus, a straight line passing through the y coordinate of the pixel in parallel with the x direction is determined.

The image comparison/determination unit 747 calculates distance (δY) 1309 between the edge line 1306 of the sheet area 1302 illustrated in FIG. 9B and a line 1305 parallel with thus determined x direction. Similarly, the image comparison/determination unit 747 further calculates a distance (εX) 1310 between the edge line 1308 of the sheet area 1302 illustrated in FIG. 9C and a line 1307 parallel with thus determined y direction.

According to a method similar to the method by which the distance between straight lines in the x direction and the y direction is calculated, a distance δX′ between the straight lines and a distance δY′ between straight lines is also calculated with respect to the reference image data. FIG. 9D illustrates each distance (δX′, δY′) between the corresponding straight lines in a reference image. FIG. 9E illustrates each distance (δX, δY) between the corresponding straight lines in thus read image data.

Finally, the calculated distances between the corresponding straight lines are compared to each other to calculate image shifting amounts ΔX and ΔY between the read image data and the reference image data based on Equation 6.

ΔX=δX′−δX [Equation 6]

For example, in a case where the calculation result is δX′=50 (pixels) and δY′=42 (pixels) in the reference image data and, in a case where the calculation result is δX=55 (pixels) and δY=40 (pixels) in the read image data, if the results are substituted into Equation 6, a result becomes as indicated in the following Equation 7.

ΔX=50−55=−5

ΔY=42−40=2 [Equation 7]

In other words, in the present exemplary embodiment, the image read from the sheet shifts in aright direction, i.e., in the x direction in FIG. 9D, by five pixels (i.e., 4.2 mm) with respect to the reference image and shifts upwardly, i.e., in the y direction in FIG. 9D, by two pixels (i.e., 1.7 mm) with respect to the reference image.

Similarly, a shifting width of the image is compared with a permissible shifting amount difference preliminarily set based on the Equation 7.

|Shifting amount|≦(permissible shifting amount difference) [Inequality 8]

In a case where the above described Inequality 8 is true, the image comparison/determination unit 747 determines that the page is OK and, in other cases, the image comparison/determination unit 747 determines that the page is OK or NG according to the conditions of the page. Since there are a shifting amount in the x direction and a shifting amount in the y direction, only in a case where both of the shifting amounts are determined as OK, the page is determined as OK in the check determination. For example, in a case where the determination is made only by using the Inequality for comparing the shifting amount with the permissible shifting amount difference, if the permissible shifting amount differences are set to three pixels in both of the X direction and the Y direction, as indicated by Equation 8, the following result can be obtained.

|ΔX|=5≦3

|ΔY|=2≦3 [Equation 9]

Consequently, the image comparison/determination unit 747 determines that the page is NG in the X direction and the page is OK in the Y direction. As a result, the checking determination is NG with respect to the page.

In the present exemplary embodiment, each of the rectangular area 1303 having the longitudinal side in an x direction and the rectangular area 1304 having the longitudinal side in a y direction is determined such that a portion of the sheet area 1302 is extracted to determine each straight line. However, since if all the rectangular areas in both of the x direction and the y direction are extracted, better accuracy can be achieved, such an extraction method may also be employable. Alternatively, since the selective extraction of each rectangular area can shorten a determination time, such an extraction method may also be employable.

In the above description, the determination of the shifting width of the image is performed by using a black and white image for the sake of shorthand. However, for example, the determination of the shifting width of the image may be selectively performed by using a CMYK image. In this case, the shifting width of a pixel may be determined per color component of each of the cyan, the magenta, the yellow, and the black to determine the color misregistration between color components.

In the present exemplary embodiment, two check determination processing methods, that is (1) the difference between the pixel values and (2) the shifting width between the images are described. However, the present exemplary embodiment is effective in the checking determination according to any other determination method.

For example, a certain character is extracted by scanning the entire sheet area 1302 to make a comparison of the inclination angle between thus extracted character and the same character in the reference image. Thus, a method for determining the inclination angle in a case where the formed image data is inclined with respect to the sheet, may be employed to perform the check determination. The description of such a method, however, is omitted in the present exemplary embodiment.

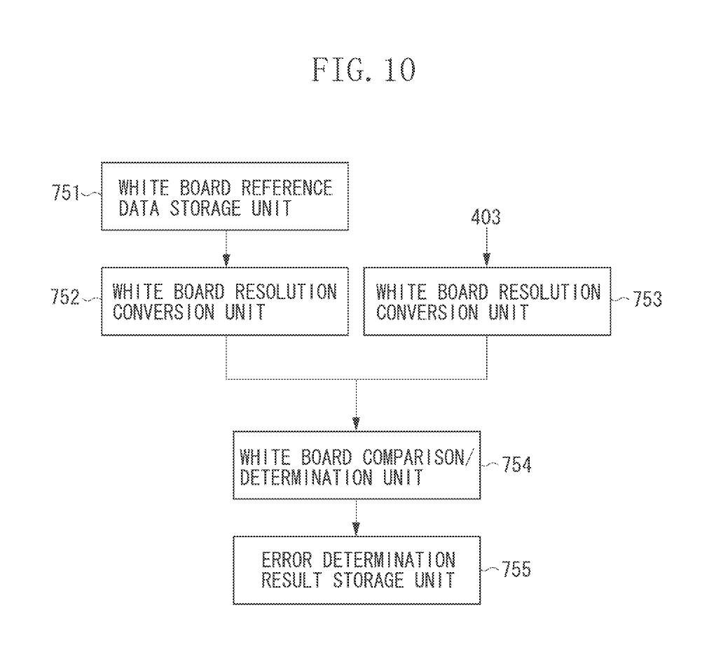

FIG. 10 is a block diagram illustrating a flow of processing performed by the error determination unit 750 of the checking apparatus 102 illustrated in FIG. 1.

In FIG. 10, the scanned image read by the check sensor 403 according to control of the sheet reading unit 720 is input into a white board resolution conversion unit 753 as image data after being converted into an electrical signal. Unlike the operation of the check determination unit 740, in the present processing, the reading operation in the check sensor 403 is performed in a state where no sheet is placed in the reading unit. In other words, a scanned image to be read at the time is not an image of a sheet but an image of the reference white board 404. A detailed reading timing is described below with reference to a flow chart.

White board reference data as original data to be used in comparison for error determination is stored in a white board reference data storage unit 751. The white board reference data is prepared such that, when the checking apparatus operates normally, for example, before it is shipped from a factory, the checking apparatus 102 reads the equipped reference white board to preliminarily store the read image in the white board reference data storage unit 751 as reference data.

The white board reference data and the white board scanned data are converted into equivalent resolutions (e.g., 300 dpi) comparable to each other, respectively by a white board resolution conversion unit 752 and a white board resolution conversion unit 753 to be transmitted to the white board comparison/determination unit 754.

However, if the reading operation is executed provided that the resolutions of the both data are identical to each other, the resolution conversion processing may be omitted. The white board comparison/determination unit 754 uses the same method as the one for calculating the difference between the pixel values which is one of the determination methods performed in the above described comparison/determination unit 747.

Accordingly, the error determination unit 750 determines whether the difference between the pixel value of the white board reference data and the pixel value of the white board scanned data does not indicate more than the permissible density difference, and whether the difference between the pixel value of the white board reference data and the pixel value of the white board scanned data does not indicate a determination ratio equal to or less than a determination threshold, thereby determining whether or not it is a checking apparatus error.

For example, in a case where a contamination such as dust and dirt is attaching to a lens of the sheet reading unit 720 or a glass of a sheet reading position, a density difference between the pixel value of the white board reference data and the pixel value of the white board scanned data becomes more than the permissible value. In other words, in a case where a pixel (i.e., an abnormal pixel) having a density largely different from that of the pixel value of the white board reference data is included in the image data of the white board read out under a condition that no sheet is placed at the reading position, the error determination unit 750 determines it as the checking apparatus error.

Further, in the determination method of the checking apparatus error according to the present exemplary embodiment, the value of the white board scanned data is compared with the white board reference data. However, the present invention is not limited thereto. Without using the reference data, under the condition that no sheet is placed at the reading position, it may also be determined whether there is no pixel (i.e., the abnormal pixel) having the density equal to or less than the threshold (i.e., a density almost equal to a white pixel) in the image read.

In a case where there is processing performed commonly between the check determination unit 740 and the error determination unit 750, for example, there is processing performed commonly in the resolution conversion processing or the comparison determination processing, the processing may be communalized.

A determination result as to the checking apparatus error is stored in the error determination result storage unit 755 and is displayed on the display unit 760 by the checking apparatus control unit 710, if necessary.

The error determination unit 750 of the present exemplary embodiment reads the reference white board 404 to determine the checking apparatus error. However, the error determination unit 750 of the present exemplary embodiment is not limited thereto but may broadly determine the checking apparatus error of the checking apparatus 102. For example, the error determination unit 750 of the present exemplary embodiment may check, for example, an entire system or a value of a sensor (not illustrated) of each unit to determine whether there is the checking apparatus error occurring due to an abnormality in its operation.

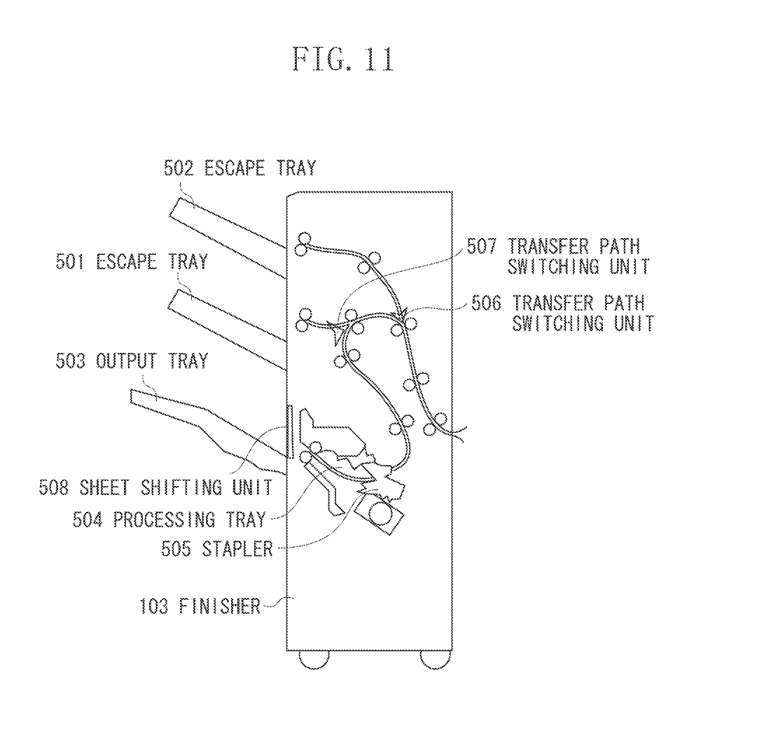

FIG. 11 is a cross sectional view illustrating an example of a configuration of the finisher (i.e., the post-processing apparatus) 103 illustrated in FIG. 1. FIG. 11 illustrates a case where the finisher 103 includes, for example, three trays (i.e., three sheet discharging units) such as an escape tray 501, an escape tray 502, and an output tray 503. However, the finisher 103 according to the present embodiment may include more than three trays. In the present exemplary embodiment, the output tray 503 functions as a first sheet discharging unit, the escape tray 501 functions as a second sheet discharging unit, and the escape tray 502 functions as a third sheet discharging unit.

In FIG. 11, the sheet discharged from the checking apparatus 102 enters into the finisher 103. The finisher 103 includes the escape tray 501, the escape tray 502, and the output tray 503, thereby discharging sheets while switching the discharge destination according to the determination result of the checking apparatus 102.

In a case where a staple mode is set to a job to be output, the transfer path switching unit 506 performs control to discharge a sheet to the output tray 503. At the time, before the sheet is discharged to the output tray 503, the sheet is sequentially stored in the processing tray 504 within the finisher per each job to be bound by a stapler 505 on the processing tray 504. Thereafter, thus stored bundle of sheets is discharged to the output tray 503.

A transfer path switching unit 506 switches a sheet transfer path according to an error determination result regarding the checking apparatus 102. A transfer path switching unit 507 switches a sheet transfer path according to a check determination result of the checking apparatus 102. As described above, by switching the transfer path for conveying sheets, the sheets can be discharged to any one of the escape tray 501, the escape tray 502, or the output tray 503.

A sheet shifting unit 508 performs a shifting operation to shift the sheets discharged onto the output tray 503 in a direction orthogonal to a sheet discharge direction. The sheets discharged according to the operation of the sheet shifting unit 508 are displaced from sheets discharged when the sheet shifting unit 508 does not operate, so that the sheets discharged according to the operation of the sheet shifting unit 508 can be discriminated from the other discharged sheets.

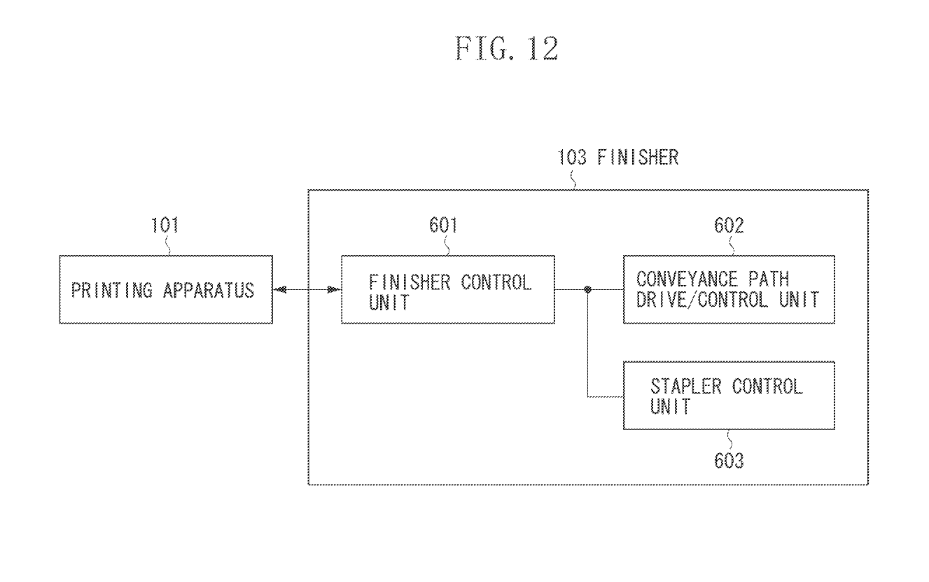

FIG. 12 is a block diagram illustrating a configuration of a control system of the finisher 103 illustrated in FIG. 1.

In FIG. 12, the printing apparatus control unit 203 within the printing apparatus 101 and a finisher control unit 601 within the finisher 103 are connected to each other via a dedicated communication line. The finisher control unit 601 receives finisher setting information according to a job from the printing apparatus 101 to establish a communication between the finisher control unit 601 and the image control unit. The image control unit controls a function of each unit within the finisher 103 based on the received setting information.

A conveyance path drive/control unit 602 guides the sheets to finishing unit based on control information for a job transmitted from the finisher control unit 601. At the time, the conveyance path drive/control unit 602 performs control to cause the transfer path switching unit 506 and the transfer path switching unit 507 to transmit the sheet to a desired tray. In a case where the user desires a stapler output, the finisher control unit 601 communicates with the stapler control unit 603, receives status information of the stapler control unit 603 to transmit control information for the job, and performs a stapler operation according to the job content to output it.

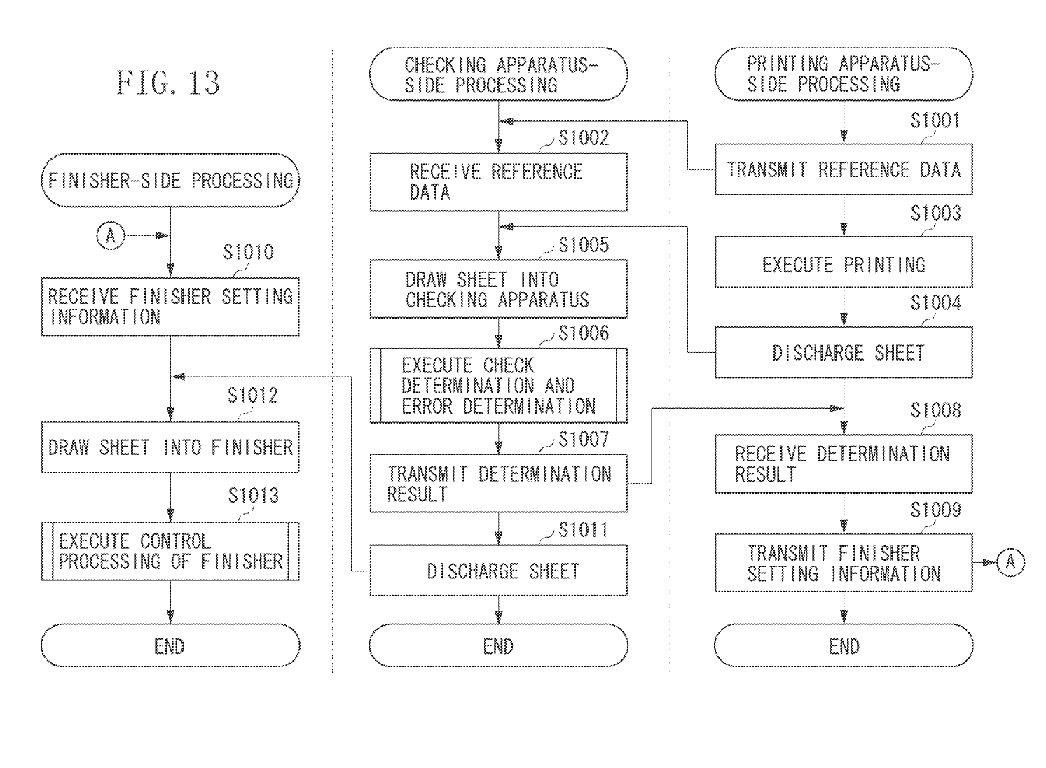

FIG. 13 is a flow chart illustrating a control method of the printing system according to the present exemplary embodiment. FIG. 1 illustrates an example of inline check processing in which CPUs of the printing apparatus 101, the checking apparatus 102, and the finisher 103 cooperate to each other to perform image forming processing, check determination processing, and finishing processing in series.

In a case where a plurality of pages of sheets is subjected to the inline check processing, the operation in the flow chart illustrated in FIG. 13 is repetitively executed. Steps on a side of the printing apparatus in FIG. 13 are executed by a CPU (not illustrated) installed within the printing apparatus control unit 203 of the printing apparatus 101. Steps on a side of the checking apparatus 102 are executed by a CPU (not illustrated) installed within the checking apparatus control unit 710 on a side of the checking apparatus 102. Steps on a side of the finisher 103 are executed such that the CPU installed within the printing apparatus control unit 203 of the printing apparatus 101 controls the finisher control unit 601 via the above described communication line.

In step S1001, the CPU of the printing apparatus 101 transmits reference data of the image to be printed to the checking apparatus 102. For example, in a case where the PDL data is printed, the CPU of the printing apparatus 101 causes the RIP unit of the NIC unit/RIP unit 202 to develop the PDL data into the raster image to store it in the memory unit 204. The data stored in the memory unit 204 is transmitted to the checking apparatus 102 as reference data.

In step S1002, the CPU of the checking apparatus 102 stores the data input into the reference data input unit 741 in the reference data storage unit 743. In step S1003, the CPU of the printing apparatus 101 controls the output image processing unit 205 and the printer unit 206 to feed a sheet and forms an image on the sheet. In step S1004, the CPU of the printing apparatus 101 discharges the sheet on which an image is formed to the checking apparatus 102 via the fixing unit 305.

In step S1005, the CPU of the checking apparatus 102 draws the sheet discharged from the printing apparatus 101 into the checking apparatus 102 by controlling drive of the paper roller 401. Driven by the paper roller 401, the sheet is conveyed onto the conveyance belt 402 of the checking apparatus 102.

In step S1006, the CPU of the checking apparatus 102 controls the check determination unit 740 and the error determination unit 750, thereby executing the check determination processing and the checking apparatus error determination processing of the checking apparatus itself. The determination processing is described below in detail.

In step S1007, the CPU of the checking apparatus 102 transmits the determination result in step S1006 to the CPU of the printing apparatus 101. In the present text, the determination result mainly indicates whether the check determination result is OK or NG and whether no checking apparatus error is occurring in the checking apparatus 102. The determination result may also contain more detailed information such as image data read out by the check sensor 403, as required. In step S1008, the CPU of the printing apparatus 101 controls the printing apparatus control unit 203 to receive the determination result transmitted according to an instruction of the CPU of the checking apparatus 102 in step S1007.

In step S1009, the printing apparatus control unit 203 generates setting information to be set to the finisher 103 based on the determination result of the checking apparatus 102 received in step S1008 to transmit the setting information to the CPU of the finisher 103. More specifically, the setting information is control information for controlling the transfer path switching unit 506 and the transfer path switching unit 507 within the finisher 103 and thus performs control to determine the tray to which the checked sheet is to be discharged. The control information may contain a staple output setting and a shifting operation setting for the sheet shifting unit 508.

In step S1010, the finisher control unit 601 within the finisher 103 receives finisher setting information transmitted from the printing apparatus 101 in step S1009. In step S1011, the checking apparatus 102 discharges the sheet having been subjected to the check determination, to the finisher 103 by using the discharge roller 406.

In step S1012, the finisher control unit 601 of the finisher 103 draws the sheet discharged from the checking apparatus 102 into the finisher 103. The finisher control unit 601 controls a conveyance destination to head the sheet to the transfer path switching unit 506. Processing of steps S1007 through S1010 is executed such that the finisher setting information is received in step S1010 before step S1012.

In step S1013, the CPU of the finisher 103 executes the control processing of the finisher 103. More specifically, the CPU of the finisher 103 performs control to drive the transfer path switching unit 506 and the transfer path switching unit 507 within the finisher 103 based on the finisher setting information received in step S1010. The finisher control unit 601 of the finisher 103 may also execute the staple output operation and the shifting operation in the sheet shifting unit 508.

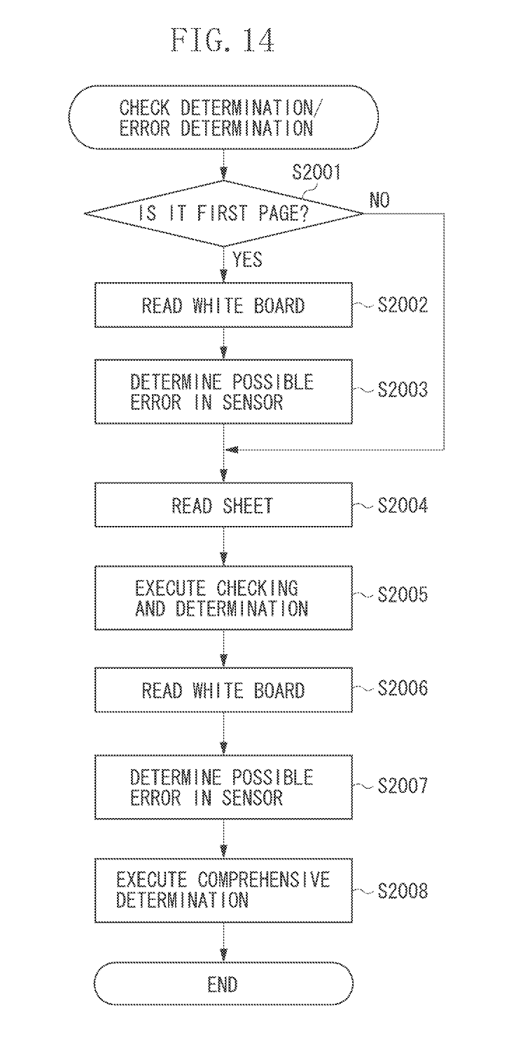

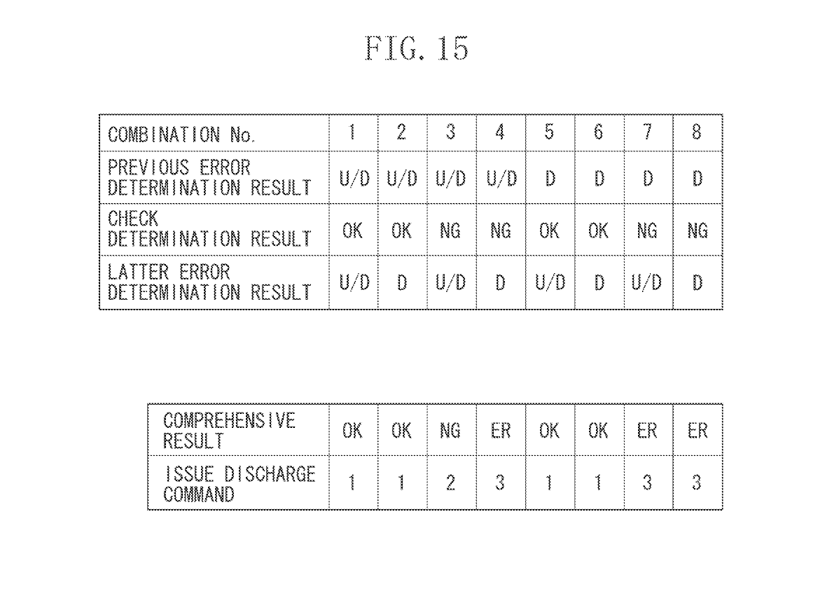

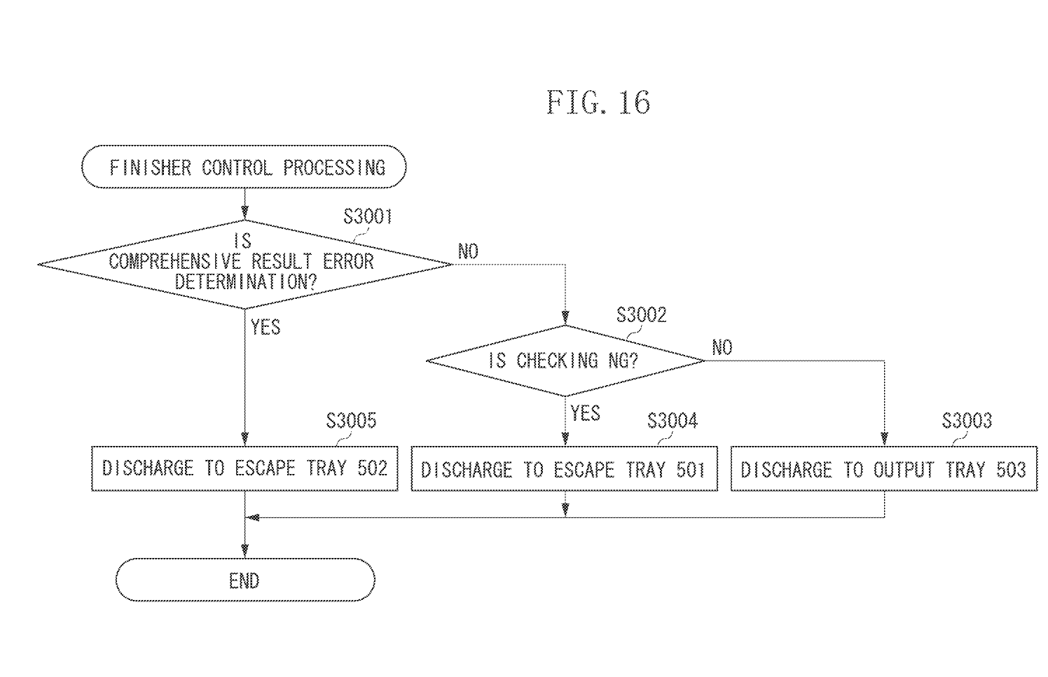

FIG. 14 is a flow chart illustrating a control method for controlling the checking apparatus according to the present exemplary embodiment. FIG. 14 illustrates detailed examples of the check determination processing and the error determination processing executed by the checking apparatus 102 in step S1006 of FIG. 13. In a case where a plurality of pages of sheets is subjected to the processing, the operation in the flow chart of FIG. 14 is repetitively executed. Each step illustrated in FIG. 14 is executed by the CPU (not illustrated) within the checking apparatus control unit 710 of the checking apparatus 102. The present processing is executed between a sheet conveyed from the printing apparatus 101 to the checking apparatus 102 and the following sheet, i.e., in a space between the sheets.

In step S2001, the CPU within the checking apparatus control unit 710 determines whether the processing is performed with respect to the first page. In a case where the CPU within the checking apparatus control unit 710 determines that the processing performed is single page processing or processing of a top page of plural page processing (YES in step S2002), the processing proceeds to step S2002. On the other hand, for example, in a case where the CPU within the checking apparatus control unit 710 determines that the processing performed is not the single page processing or the processing of the top page of the plural page processing (NO in step S2002), the processing proceeds to step S2004.

In step S2002, the CPU within the checking apparatus control unit 710 executes reading processing to read the reference white board 404 by using the check sensor 403. More specifically, the reading processing is executed such that the check sensor 403 reads the reference white board 404 according to control of the sheet reading unit 720. As described above, the reading operation in the check sensor 403 is performed under the condition that no sheet is placed on the reading unit, therefore, thus read scanned image is data of the reference white board 404. At the time, the sheet has not been conveyed to the reading position of the check sensor 403 yet.

In step S2003, the CPU within the checking apparatus control unit 710 executes processing to determine a state of an checking apparatus error based on whether the checking apparatus 102 itself can normally read the sheet or cannot read the sheet. More specifically, the CPU within the checking apparatus control unit 710 controls the error determination unit 750 to execute the determination processing of the checking apparatus error by comparing the read out white board data with preliminarily stored white board reference data.

In step S2004, the CPU within the checking apparatus control unit 710 controls the check sensor 403 to execute the reading of the conveyed sheet. More specifically, the check sensor 403 is configured to read the sheet conveyed on the conveyance belt 402 at a time when the sheet is conveyed to a position on the reference white board 404. The present control is executed by the sheet reading unit 720 in a manner similar to step S2002 except for timing. More specifically, the present control is executed when the sheet is in the reading unit. Then, in step S2005, the check determination unit 740 of the checking apparatus 102 executes the above described series of processing and stores the determination result in the determination result storage unit 748.

In step S2006, the reading processing for reading the reference white board 404 is executed by using the check sensor 403. The reading operation itself is identical to that performed in step S2002 except for the timing at which the reading operation is executed. More specifically, the operation should be performed at timing of the sheet passing through the reading position of the check sensor 403 and being conveyed on the conveyance belt 405.

In step S2007, the CPU within the checking apparatus control unit 710 executes the determination processing about the checking apparatus error to detect whether the checking apparatus 102 itself can normally read or cannot normally read the sheet. The error determination operation is identical to what is performed in step S2003. In step S2008, the CPU within the checking apparatus control unit 710 generates the comprehensive determination result by using the error determination result in above described steps S2003 and S2007 and the check determination result in step S2005. Then, the processing is ended.

FIG. 15 is a table illustrating an example of a comprehensive determination result generated by the checking apparatus according to the present exemplary embodiment. In FIG. 15, the error determination result obtained in steps S2002 and S2003 illustrated in FIG. 14 is indicated as a “previous error determination result”, and the error determination result in steps S2006 and S2007 illustrated in FIG. 14 is indicated as a “latter error determination result”.

The check determination result in steps S2004 and S2005 is indicated as a “check determination result”. A “U/D” in the previous error determination result and the latter error determination result illustrated in FIG. 15 indicates a result that no checking apparatus error was detected in the checking apparatus 102 and a “D” therein indicates a result that a checking apparatus error was detected.

The “OK” indicates a state of check OK of the read image and the “NG” indicates a state of check NG in the check determination result illustrated in FIG. 15. The comprehensive determination result indicates a result finally determined by the checking apparatus 102. In FIG. 15, an “OK” indicates the check OK, an “NG” indicates the check NG, and an “ER” indicates the checking apparatus error.

A “combination No.” indicates a number provided to each combination of three determination results illustrated in FIG. 15. In the present exemplary embodiment, the combination Nos. 1, 2, 5, and 6 indicate a comprehensive result of OK. Specifically, in the combination Nos. 2, 5, and 6, the CPU within the checking apparatus control unit 710 determines the result as OK since thus detected checking apparatus error was removed before or after the check determination processing, and thus determines that the check determination could be normally executed.

For example, although the error determination has resulted in “D” due to dirt attaching to the reference white board 404 before and after the error determination is made, the dirt may be blown out by some factor such as air blowing while a printing sheet conveyance before and after the check determination. Such a case corresponds to the above described situation.

In the combination Nos. 4, 7, and 8, the comprehensive result is ER. This is because the CPU within the checking apparatus control unit 710 determines that the detected checking apparatus error might have affected the check determination processing. In the combination No. 3, the comprehensive result is NG. This is because the CPU within the checking apparatus control unit 710 determines the result as check NG although no checking apparatus error is found in the checking apparatus 102.

In a case where a plurality of pages is subjected to the processing, processing of steps S2002 and S2003 will not be executed on and after the second page. In this case, a “latter error determination” made in the processing of the previous page is applied as a “previous error determination” of the next page.

The processing for determining the checking apparatus error in, for example, steps S2002, S2003, S2006, and S2007 illustrated in the present flow chart may control execution timing, for example, the execution is performed once for a plurality of pages, only at a time of starting a job, or only at a time of terminating a job, in consideration of the adverse effect to the processing performance.

FIG. 16 is a flow chart illustrating a control method of the finisher according to the present exemplary embodiment. FIG. 16 illustrates a finisher control processing flow to be executed by the finisher 103. More specifically, FIG. 16 illustrates a finisher control of step S1013 in FIG. 13 in detail. In a case where a plurality of pages is subjected to the processing, an operation illustrated in the flow chart of FIG. 16 is repetitively executed.

A processing flow control of the finisher 103 of FIG. 16 is performed such that the CPU within the printing apparatus control unit 203 of the printing apparatus 101 controls the finisher control unit 601 via the above described communication line. Control for switching the sheet discharge destination will be described in a case where the finisher 103 determines that an image printed on the sheet cannot be normally read.

More specifically, as a first type of control, the sheet conveyed from the printing apparatus 101 to the checking apparatus 102 is discharged to a first sheet discharging unit to which the sheet with check result of OK is to be discharged. As a second type of control, the sheet conveyed from the printing apparatus 101 to the checking apparatus 102 is controlled to be discharged to a second output tray to which the sheet with the check result of NG is to be discharged. These two types of controls will be described below. Further, in a case where the finisher 103 determines there is the checking apparatus error, the sheet is discharged to a third sheet discharging unit other than the first sheet discharging unit and the second sheet discharging unit.

In step S3001, the finisher 103 refers to the finisher setting information that the finisher control unit 601 receives from a side of the printing apparatus 101 to make a determination whether the sheet drawn into the finisher 103 is to be discharged to the escape tray 502 in step S1012. For example, in a case where the comprehensive result indicated in FIG. 15 is the “error (ER)” (YES in step S3001), the processing proceeds to step S3005, whereas, in a case where the comprehensive result indicated in FIG. 15 is the “OK” (NO in step S3001), the processing proceeds to step S3002.

In step S3002, the finisher 103 refers to the finisher setting information received by the finisher control unit 601 to make a determination whether the sheet drawn into the finisher 103 in step S1012 is to be discharged to the escape tray 501 or to the output tray 503. For example, in a case where the comprehensive result indicates the “NG” in FIG. 15 (YES in step S3002), the check result becomes “D” and the processing proceeds to step S3004, whereas, in a case where the comprehensive result indicates the “OK” in FIG. 15 (NO in step S3002), the check result becomes “U/D” and the processing proceeds to step S3003.

In step S3003, the finisher control unit 601 of the finisher 103 performs paper discharge processing to discharge paper drawn into the finisher 103 in step S1012 to the output tray 503. Then, the present processing is ended. More specifically, the finisher control unit 601 of the finisher 103 controls the conveyance path drive/control unit 602 to thereby control the transfer path switching unit 506 and the transfer path switching unit 507. As a result, the finisher control unit 601 of the finisher 103 performs the processing to guide the checked sheet, to the output tray 503. At the same time, the stapling processing and the shifting processing by the sheet shifting unit 508 may also be performed.

On the other hand, in step S3004, the finisher control unit 601 of the finisher 103 performs paper discharge processing to discharge paper drawn into the finisher 103 in step S1012 to the escape tray 501. More specifically, the finisher control unit 601 of the finisher 103 controls the conveyance path drive/control unit 602 to thereby control the transfer path switching unit 506 and the transfer path switching unit 507. As a result thereof, the finisher control unit 601 of the finisher 103 performs the processing to guide the sheet to the escape tray 501. Then, the present processing is ended.

In step S3005, the finisher control unit 601 of the finisher 103 performs the processing to discharge the sheet drawn into the finisher 103 in step S1012 to the escape tray 502. More specifically, the finisher control unit 601 of the finisher 103 controls the conveyance path drive/control unit 602 to thereby control the transfer path switching unit 506. As a result, the finisher control unit 601 of the finisher 103 performs the processing to guide the sheet to the escape tray 502.

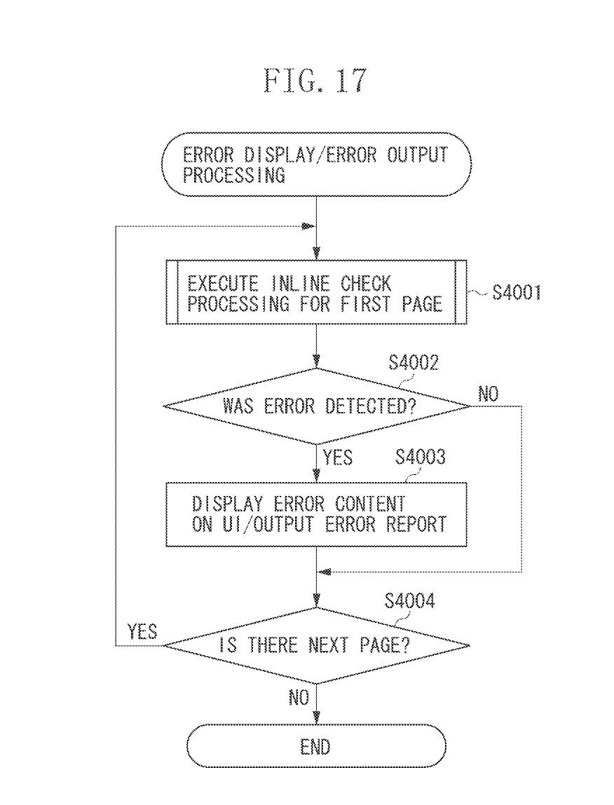

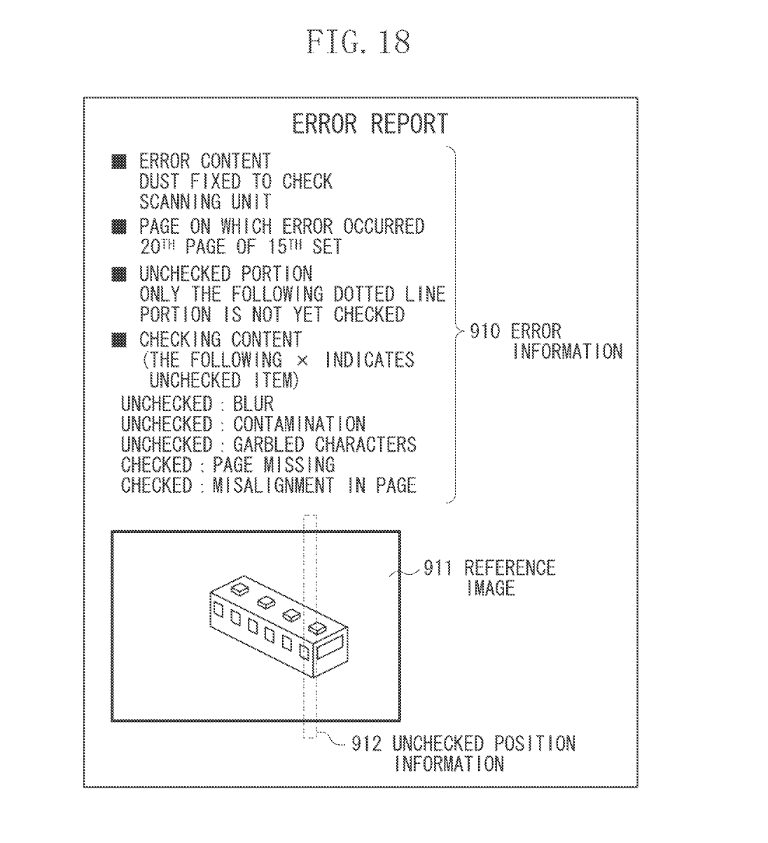

FIG. 17 is a flow chart illustrating a control method of the printing system according to the present exemplary embodiment. FIG. 1 illustrates an error display processing and output processing flow to be executed by the printing apparatus 101, the checking apparatus 102, and the finisher 103 in cooperation with each other. Each step is realized such that the CPU of the printing apparatus 101 and the CPU of the checking apparatus 102 execute control programs. In step S4001, the inline check processing is executed with respect to the first page. This processing corresponds to the execution of the inline check processing flow illustrated in FIG. 13.

In step S4002, the CPU of the printing apparatus 101 determines whether an error of the checking apparatus 102 is detected in the inline check processing of step S4001. In a case where the CPU of the printing apparatus 101 determines that the error of the checking apparatus 102 is detected (YES in step S4002), the processing proceeds to step S4003. In a case where the CPU of the printing apparatus 101 determines that the error of the checking apparatus 102 is not detected (NO in step S4002), the processing proceeds to step S4004.

In step S4003, the CPU of the printing apparatus 101 outputs information relating to the checking apparatus error. A detailed description of the error may be printed and output in the form of an error report or may be displayed on a UI screen (not illustrated) of the operation unit 207 of the printing apparatus 101 or of the display unit 760 of the checking apparatus 102.

A case of outputting error in the printed form of the error report is described below. The checking apparatus control unit 710 of the checking apparatus 102 transmits information such as error content and a reference image in the determination result storage unit 748 to the printing apparatus 101 via the external communication unit 770. The printing apparatus control unit 203 forms the received information into an image of an error report. Then, the output image processing unit 205 and the printer unit 206 execute the print processing of the error report. The printing apparatus control unit 203 generates setting information with respect to the finisher 103 so that the present error report is discharged to the tray where the sheet determined as an error was discharged, i.e., to the escape tray 502. Thereafter, the printing apparatus control unit 203 transmits the setting information to the finisher 103.

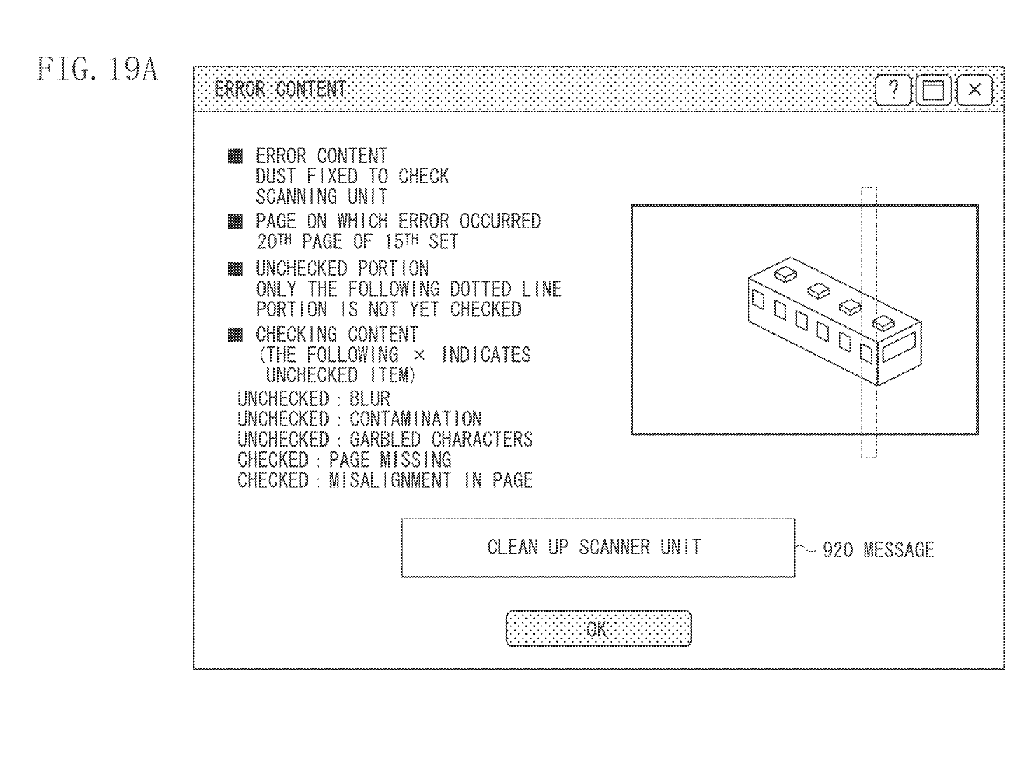

The checking apparatus 102 does not execute the check processing with respect to the error report. Accordingly, the user can refer to the error report discharged to the tray identical to the one to which the sheet determined as an error is discharged (i.e., the third sheet discharging unit). The user can determine how to do with the sheet determined as the error according to the content of the error report as exemplified in FIG. 18.

FIG. 18 illustrates an example of the error report output by the printing apparatus 101 according to the present exemplary embodiment. In FIG. 18, the error report contains a reference image 911 and an unchecked position information 912, and error information 910 of, for example, unchecked items. The reference image 911 is a printed image. The error information 910 indicates an error content (i.e., a reason) and an error page. The unchecked position information 912 indicates an area of a page where no check was performed. The user can visually check the error report with a minimum load. The user can treat a result of the check as OK if there is no problem, and treat a result of the check as NG if there is a problem.

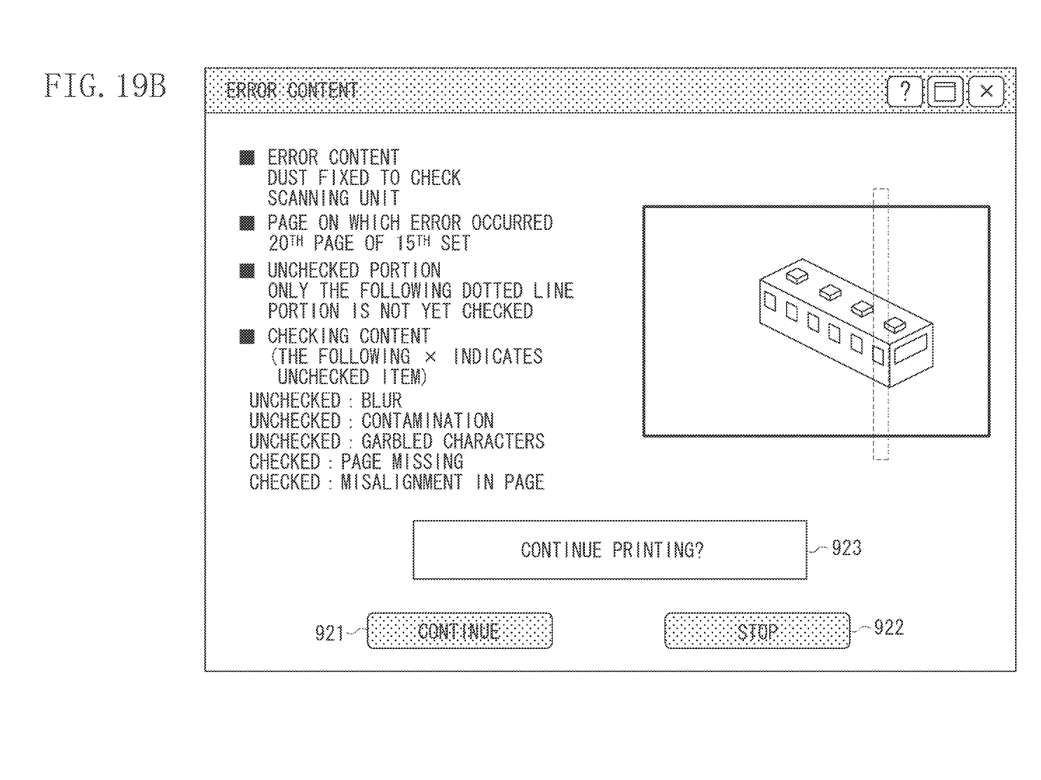

A case will be described where the printing apparatus 101 causes a UI screen to display the error report necessary for notifying the subsequence processing to the user. First, in a case where the printing apparatus 101 causes the UI screen of the operation unit 207 to display the error information, the printing apparatus control unit 203 receives the error information from the checking apparatus control unit 710, thereby causing the UI screen on the printing apparatus 101 to display the error information. In a case where the error report is displayed on the UI screen of the display unit 760 of the checking apparatus 102, the checking apparatus control unit 710 causes the UI screen to display the information of the error content and the reference image stored in the determination result storage unit 748 on the UI screen, for example, in the form of an example illustrated in FIG. 19.

FIG. 19 exemplifies the UI screen which can be displayed by the printing apparatus 101 according to the present exemplary embodiment. FIG. 19 is an example illustrating the UI screen for receiving an instruction to continue printing as the above described error report and the subsequent processing with respect to the error information, unchecked position information, and the reference image. FIG. 19A displays the error information, the unchecked position information, and the reference image in a manner similar to the error report. Also, the display unit of the operation unit 207 of the printing apparatus 101 may display a message 920 for encouraging the user, for example, to clean the scanner unit which the user should do with respect to the checking apparatus error.

Further, as illustrated in FIG. 19B, in a case where a confirmation message 923 for confirming the continuous printing is displayed here, if the user selects a “continue” 921, the inline check processing may be continued. On the other hand, if the user selects a “stop” 922, the inline check processing may be stopped. The description returns to FIG. 17 below.

In step S4004 illustrated in FIG. 17, the CPU of the printing apparatus 101 determines whether there is the next page to be processed. In a case where the CUP of the printing apparatus 101 determines that there is the next page (YES in step S4004), the processing returns to step S4001. In a case where the CPU of the printing apparatus 101 determines that there is not the next page (NO in step S4004), the present processing is ended.

Accordingly, the discharge destination of each sheet, i.e., the destination to which the sheet is sorted, e.g., the destination to either one of the check OK, the check NG, and the checking apparatus error (ER), can be clearly notified to the user. Accordingly, in a case where the check processing error occurs due to the checking apparatus itself in a state that the printing apparatus 101 can execute the normal print processing, the degradation of the user's usability and the decrease of the productivity can be reduced to a minimum level.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium). In an example, a computer-readable storage medium may store a program that causes a checking system or apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-030522 filed Feb. 15, 2012, which is hereby incorporated by reference herein in its entirety.

What is claimed is:

1. A checking system comprising:
a checking unit configured to check a print product, printed by a printing unit, by using a reading unit to read the print product; and
a control unit configured to perform control,
wherein, in response to the reading unit being normal and the checking unit determining a print product as normal, the print product is discharged to a first sheet discharging unit,
wherein, in response to the reading unit being normal and the checking unit determining a print product as abnormal, the print product is discharged to a second sheet discharging unit that is different from the first sheet discharging unit, and
wherein, in response to the reading unit being abnormal, the print product is discharged to a third sheet discharging unit that is different from the first sheet discharging unit and the second sheet discharging unit.

2. A checking system according to claim 1, further comprising:
a notification unit configured to notify a user, in response to the print product being discharged to the third sheet discharging unit, that the print product printed by the printing unit could not be correctly read by the reading unit.

3. A checking system according to claim 2, wherein the notification unit notifies the user, in response to the print product printed by the printing unit being discharged to the third sheet discharging unit, of a print product produced after the reading unit becomes abnormal.

4. A checking system according to claim 2, wherein the notification unit notifies the user, in response to the print product printed by the printing unit being discharged to the third sheet discharging unit, of an area that could not be correctly read by the reading unit.

5. A checking system according to claim 2, wherein the notification unit issues a notification to the user by printing the notification on a sheet.

6. A checking system according to claim 1, wherein the control unit perform control, wherein, in response to a foreign matter attaching to a reading position to be read by the reading unit, the print product printed by the printing unit is discharged to the third sheet discharging unit.

7. A control method for controlling a checking system, the control method comprising:
checking a print product, printed by a printing unit, by using a reading unit to read the print product; and
performing control,
wherein, in response to the reading unit being normal and the checking determining a print product as normal, the print product is discharged to a first sheet discharging unit,
wherein, in response to the reading unit being normal and the checking determining a print product as abnormal, the print product is discharged to a second sheet discharging unit that is different from the first sheet discharging unit, and
wherein, in response to the reading unit being abnormal, the print product is discharged to a third sheet discharging unit that is different from the first sheet discharging unit and the second sheet discharging unit.

8. A non-transitory computer readable storage medium storing a computer program causing a checking system to perform the method according to claim 7.
